(19) United States
(12) Patent Application Publication
(10) Pub. No.: US 2025/0078363 A1
(43) Pub. Date: Mar. 6, 2025

(54) METHOD AND SYSTEM FOR PROVIDING CONTENTS

(71) Applicant: NAVER WEBTOON LTD., Seongnam-si (KR)

(72) Inventors: Ji Hyeon KANG, Seongnam-si (KR); Choong Hyun SEO, Seongnam-si (KR); Seung Hun NAM, Seongnam-si (KR); Won Hyuk AHN, Seongnam-si (KR)

(21) Appl. No.: 18/816,612

(22) Filed: Aug. 27, 2024

(30) Foreign Application Priority Data
Aug. 28, 2023 (KR) 10-2023-0113139

(51) Int. Cl. G06T 11/60

(52) U.S. Cl. CPC G06T 11/60

(57) ABSTRACT

A method and a system for providing content include receiving a viewing request for content from a user terminal, identifying user information for a user account logged into the user terminal, editing a plurality of scene images constituting the content on the basis of the user information, and providing the edited content to the user terminal.

### CROSS REFERENCE TO RELATED APPLICATION

The present application claims priority to Korean Patent Application No. 10-2023-0113139, filed on Aug. 28, 2023, the entire contents of which are incorporated herein for all purposes by this reference.

### BACKGROUND OF THE INVENTION

### Field of the Invention

The present invention relates to a method and a system for providing content in which information related to a user is inserted for copyright protection of the content.

### Description of Related Art

As technology advances, the use of a digital device increases. In particular, electronic devices (e.g., smartphone, tablet PC, etc.) are equipped with various functions including communication functions such as telephonic or text messaging, as well as functions for allowing the user to surf the web, listen to music, and watch image content using the Internet.

With the popularization of these electronic devices, consumption of content is rapidly increasing, and as a representative example of such content, there is content comprising visualized images (e.g., comics content).

With the increasing consumption of such content, various ways to protect the copyright of the content are being actively researched. Representatively, a method of protecting a copyright on content by providing the content using a digital watermark and a fingerprint has been made publicly known in the art.

In recent years, there have been many cases of copyright infringement of content through a way of illegally capturing and filming content, editing the content into videos or images, and leaking the content.

Accordingly, there is a need for a method of inserting information related to a user into content for copyright protection of content comprising visual information (e.g., an image).

### BRIEF SUMMARY OF THE INVENTION

The present invention relates to a method and a system for providing content to protect copyright on content provided as an image.

Further, the present invention relates to a method and a system for providing content that is capable of protecting copyright by coping with various methods of illegal copying and distribution.

Therefore, the present invention may be implemented to infer user-related information from content provided to a user terminal.

A method of providing content, according to the present invention, may include receiving a viewing request for content from a user terminal, identifying user information for a user account logged into the user terminal, editing a plurality of scene images constituting the content on the basis of the user information, and providing the edited content to the user terminal.

A system for providing content, according to the present invention, may include a communication unit configured to receive a viewing request for content from a user terminal, and a control unit configured to identify user information for a user account logged in to the user terminal, in which the control unit may edit a plurality of scene images constituting the content on the basis of the user information, and provide the edited content to the user terminal.

There is provided a program executed by one or more processors on an electronic device and capable of being stored on a computer-readable recording medium, according to the present invention. The program may include instructions to perform receiving a viewing request for content from a user terminal, identifying user information for a user account logged into the user terminal, editing a plurality of scene images constituting the content on the basis of the user information, and providing the edited content to the user terminal.

The method and a system for providing content according to the present invention can edit and provide an image on the basis of user information, thereby inserting the user information into the image constituting the content.

In the present invention, user information can be inserted into content by removing or editing an image, thereby detecting various types (screen capture, photographing with a camera, or the like) of illegal copying and distribution of content.

According to various embodiments of the present invention, distortions to an important story of content can be avoided by retaining a story that includes the important story of an image, and performing editing only on the remaining area.

### BRIEF DESCRIPTION OF THE DRAWINGS

FIG. 1 is a block diagram for describing a system for providing content according to the present invention.

FIG. 2 is a flowchart for describing a method of providing content according to the present invention.

FIG. 3 is an illustration for describing a state in which differently edited content is provided according to user information.

FIG. 4, FIG. 5, FIG. 6, and FIG. 7 are illustrations for describing a method of editing content in the present invention.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals, and the repetitive description thereof will be omitted. The terms “module”, “unit”, “part”, and “portion” used to describe constituent elements in the following description are used together or interchangeably in order to facilitate the description, but the terms themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to a method and a system for providing content that is capable of providing differently edited versions of original content on the basis of content information to extract a leaker who illegally leaks (distributes) content by copying the original content (e.g., photographing, recording, or capturing, and the like).

With the increase in consumption of content, there have been continuing cases of illegal distribution of content, in particular, paid product type of content, e.g., using content through viewing rights or payment of electronic currency (e.g., cookies and the like).

Research on technologies that identify leakers by inserting identification information on illegally distributed users into content (e.g., images constituting the content) (e.g., watermarks) is actively being conducted, but the leakers are aware of the existence of watermarks and continue to attempt to evade the watermarks.

In particular, when the content is leaked as an “image,” such as by photographing, recording, or otherwise capturing the content, it is difficult to extract complete information from the watermark when image manipulation attacks (e.g., various signaling attacks or geometric transformations) are applied to the content using a camera.

Accordingly, the present invention proposes a technology for editing and providing content on the basis of user information.

More specifically, in the present invention, original content may be edited differently on the basis that users viewing (or using) content have different user information, and content having a different visual appearance (e.g., resolution, horizontal and vertical ratio, or the like) may be displayed on each of the user terminals on the basis that the original content has been edited differently.

Therefore, when the content provided in the present invention is leaked, a user who leaked the content may be detected by comparing the leaked content to the original content and extracting user information reflected in the leaked content.

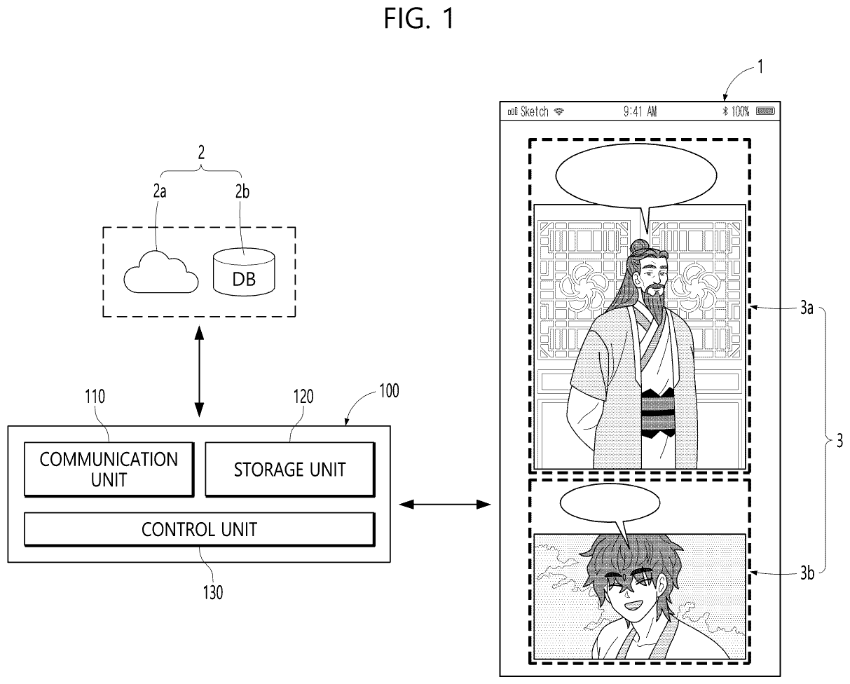

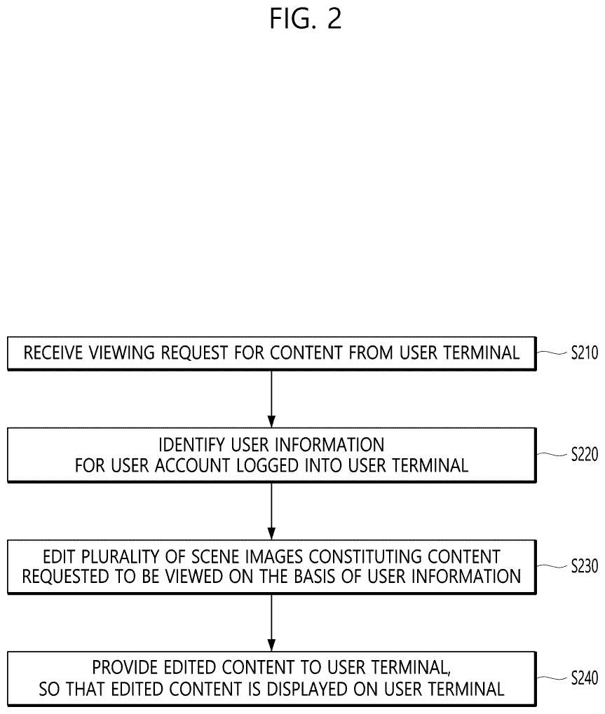

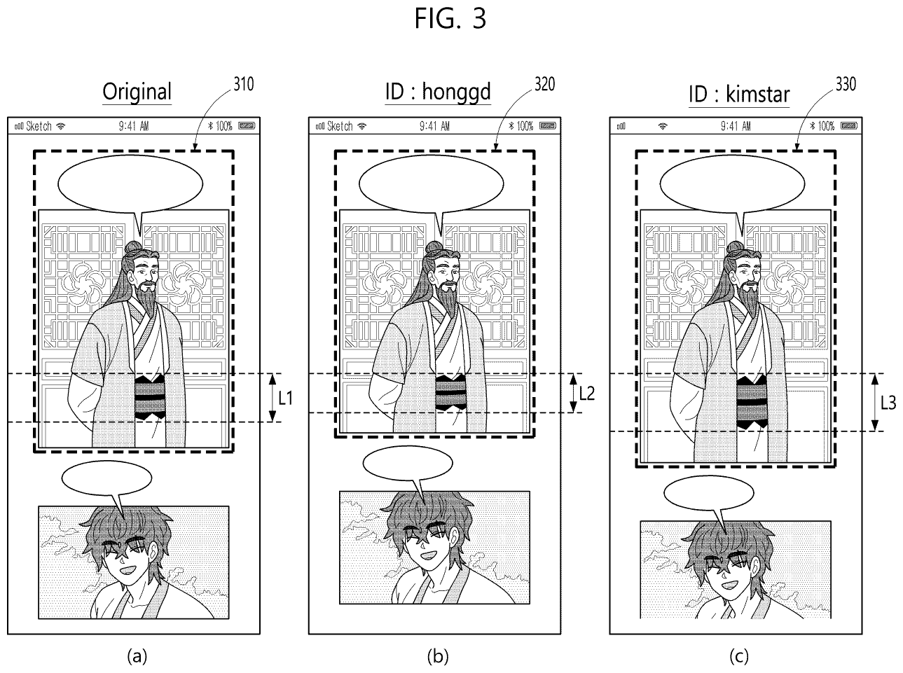

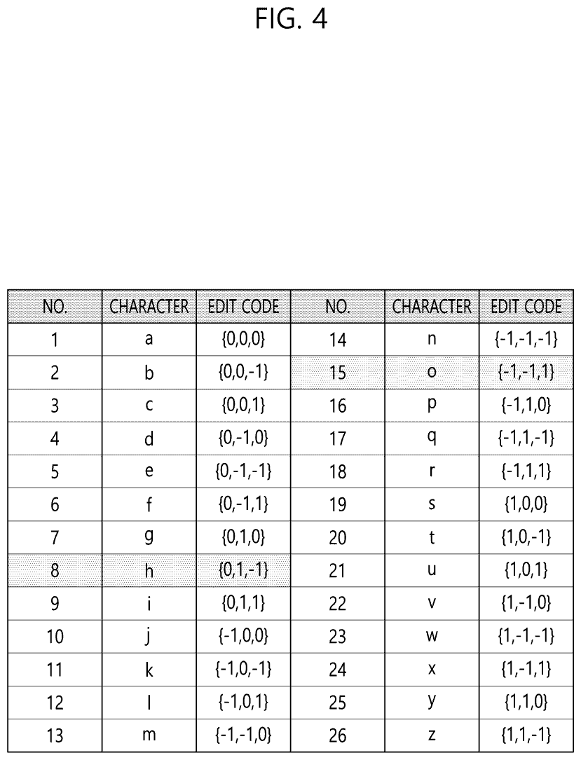

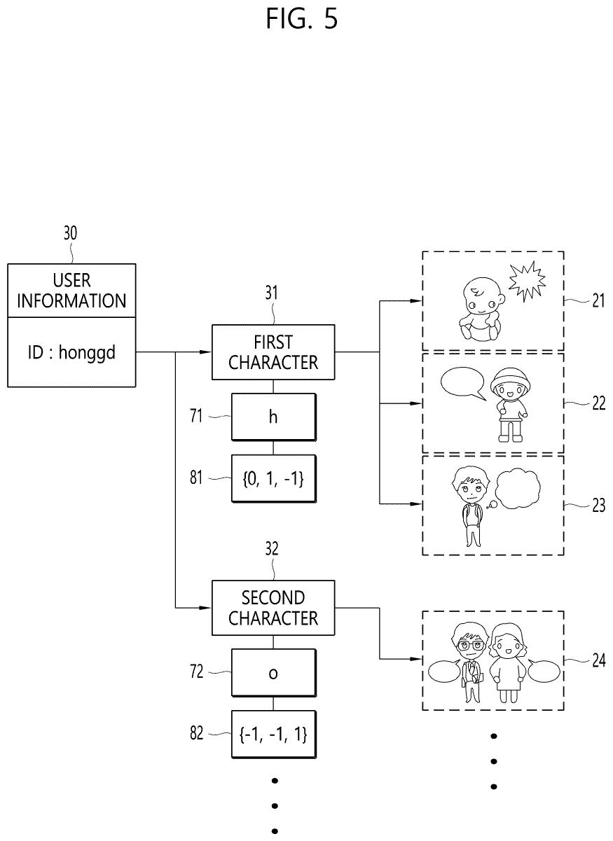

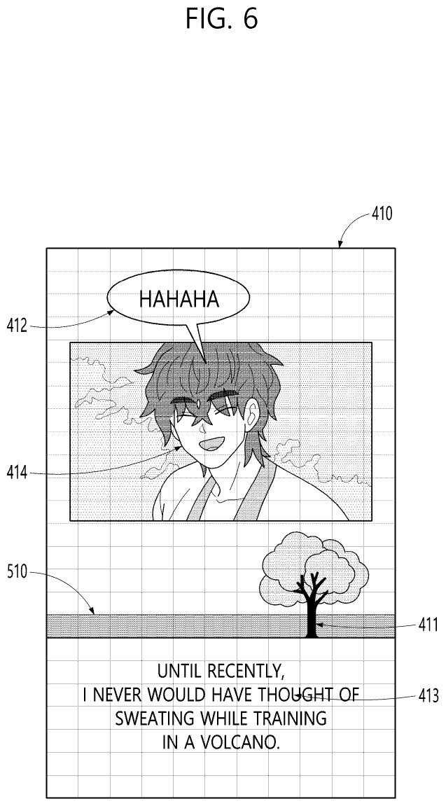

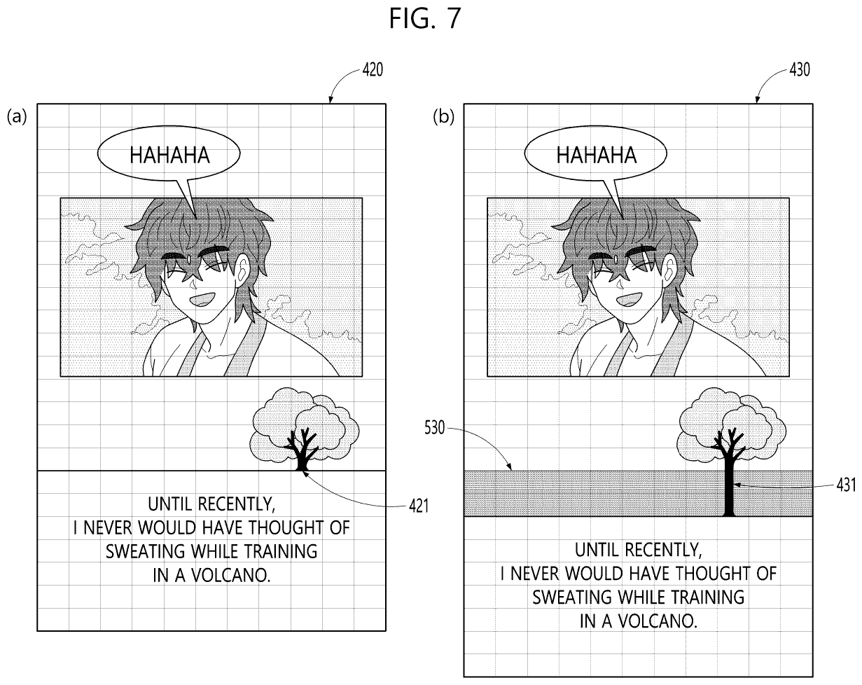

Hereinafter, a method and a system for providing content in the present invention will be described with reference to the accompanying drawings. FIG. 1 is a block diagram for describing a system for providing content according to the present invention. FIG. 2 is a flowchart for describing a method of providing content according to the present invention, FIG. 3 is an illustration for describing a state in which differently edited content is provided according to user information, and FIG. 4, FIG. 5, FIG. 6, and FIG. 7 are illustrations for describing a method of editing content in the present invention.

As illustrated in FIG. 1, a system 100 for providing content according to the present invention may include at least one of a communication unit 110, a storage unit 120, or a control unit 130.

The communication unit 110 may be configured to perform communications with at least one of a user terminal 1 and a content server 2.

The communication unit 110 may, in response to receiving a content viewing request from the user terminal 1, edit content on the basis of user information and provide the content to the user terminal 1.

The user terminal 1 is an electronic device on which content may be used and is not limited in type. For example, the user terminal 1 may be a cell phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)), and the like.

The communication unit 110 may receive content from the content server 2 in order to provide content to the user terminal 1.

The content server 2 may be understood as a server that provides content services. The content server 2 may include at least one of a cloud server 2a, which performs a series of functions of controlling a content service, and a database (DB) 2b, in which a plurality of content is stored.

The content stored in the database 2b may be referred to as “original content” in the present invention. The original content may be understood as content that has not been edited on the basis of user information.

In contrast, the content provided to the user terminal 1 in the present invention may be referred to and described as “edited content” 3.

The content described in the present invention may comprise a “plurality of scene images”. The scene images may constitute an episode or story of content, and an order of each of the scene images may correspond to an order that constitutes an episode. An order of a scene image that constitutes a first story of an episode may correspond to a first order, an order of a scene image that constitutes a next story may correspond to a second order, and an order of a scene image that constitutes the next story may correspond to a third order.

In the present invention, at least some of the plurality of scene images constituting the original content may be edited and provided to the user terminal 1. As illustrated in FIG. 1, the user terminal 1 may display a plurality of edited scene images 3a and 3b in sequence to correspond to a scene order.

The content server 2 may perform a function of editing the original content on the basis of user information, and providing the edited content 3 to the user terminal 1. That is, the system 100 for providing content according to the present invention may correspond to the function of the content server 2. Accordingly, the storage unit 120 described below may be used interchangeably with the database 2b of the content server 2, and the control unit 130 may be used interchangeably with the cloud server 2a.

Various information for providing the edited content 3 may be stored and present in the storage unit 120. User accounts and user information matched to the user accounts may be stored and present in the storage unit 120.

A user account may be understood as an account that is subscribed to a content service (or a system for providing content). The user information matched to each user account may include at least one of information on the user account (e.g., identification, ID), a user's name, a nickname, identification code information (e.g., a hash code generated by a hash function), and unique information that can identify the user.

Further, edit code information (see FIG. 4) that is a basis for editing content may be present in the storage unit 120 on the basis of the user information.

Different edit codes may be matched to each character that constitutes the user information in the edit code information. For example, as illustrated in FIG. 4, assume that 26 lowercase letters of the alphabet are set as characters to constitute the user information. In the edit code matching information, different edit codes may be matched to each lowercase letter of the alphabet (A to Z).

Here, the edit code may be understood as information that defines an editing style for the original content. More specifically, the edit code may be understood as information that defines which scene image, among the plurality of scene images constituting the original content, needs be edited in what order and with what editing style. For example, an edit code “{0,1,-1}” matched to a lowercase letter “h” of the alphabet may be understood to be defined as performing an edit corresponding to “0” for a first scene image (e.g., no change to the scene image, “nothing”), an edit corresponding to “1” for a second scene image (e.g., inserting a pixel, “insertion”), and an edit corresponding to “−1” for a third scene image (e.g., removal of a pixel, “removal”).

Further, as described above, at least a portion of the storage unit 120 may mean the database 2b of the content server 2. That is, in the present invention, it may be understood that the storage unit 120 is sufficient to be a space in which the information related to the present invention is stored, and there is no restriction on a physical space.

The storage unit 120 may be configured to control an overall operation of the system 100 for providing content related to the present invention. It may be understood that the communication unit 110 and storage unit 120 described above may be controlled by the control unit 130. The control unit 130 may be any device capable of processing data including, for example, a processor. The term ‘processor,’ as used herein, refers to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multiprocessor, an application-specific integrated circuit (ASIC), and a field programmable gate array (FPGA).

Hereinafter, a method of editing and providing original content on the basis of user information is described in detail.

In the present invention, a process of receiving a viewing request for content from the user terminal may proceed (S210, see FIG. 2).

The control unit 130 may receive a viewing request from the user terminal 1 for specific content among a plurality of content provided in a content service.

The viewing request for content from the user terminal 1 may be made in a variety of ways.

For example, on a service page that includes information on each of a plurality of content (e.g., a thumbnail, a title, and the like), the control unit 130 may receive a viewing request for a specific content from the communication unit 110 on the basis of information on the specific content (e.g., a thumbnail) being selected.

In another example, on a service page related to specific content, the communication unit 110 may receive a viewing request for a specific episode from the user terminal 10 on the basis of one of a plurality of episodes constituting the specific content being selected.

In the present invention, a viewing request for an episode constituting specific content may be described as a viewing request for content.

In the present invention, user information for a user account logged into the user terminal may be identified (S210, FIG. 2).

The control unit 130 may identify the user information for the user account logged into the user terminal 1 on the basis of receiving a viewing request for specific content from the user terminal 1.

The control unit 130 may provide a login page to the user terminal 1 when the user terminal 1 is in a non-login state, so that a user's login may proceed first.

As described above, the user information may include at least one of information on the user account (e.g., identification, ID), a user's name, a nickname, identification code information (e.g., a hash code generated by a hash function), and unique information that can identify the user.

In the present invention, a process of editing a plurality of scene images constituting content requested to be viewed on the basis of user information may proceed (S230, see FIG. 2).

The process of editing may be understood as a process of inserting the user information in the content, through editing of the plurality of scene images. The control unit 130 may perform editing on the plurality of scene images according to an edit code matched to a text character constituting user information, thereby inserting the user information into the plurality of scene images. Each text character can be associated with a unique code that allows it to be processed, stored, and manipulated. For example, lowercase letters (a to z) each have a distinct code that enables their use in text input, storage, and transformation.

The control unit 130 may specify an editing style for each of specified scene images on the basis of the edit code matched to the character constituting the user information.

An edit code is information that defines an editing style of an edit to be performed for each of a plurality of scene images, and different editing styles may be matched to each of the code values constituting the edit code.

In the present invention, each of the plurality of scene images may be edited according to any one of first to third editing styles that are different from each other. The first editing style may be an editing style that inserts additional pixels into a scene image to be edited among the plurality of scene images, the second editing style may be an editing style that removes some pixels of the scene image to be edited among the plurality of scene images, and the third editing style may be an editing style that retains the scene image to be edited among the plurality of scene images.

For example, in the present invention, a code value of “1” may be matched to the first editing style, a code value of “−1” may be matched to the second editing style, and a code value of “0” may be matched to the third editing style, respectively.

The scene image may be edited in one of editing styles of i) an edit that adds pixels to a scene image (the first editing style), ii) an edit that removes pixels forming a specific area of the scene image from the scene image (the second editing style), or iii) an edit that keeps the scene image unedited (the third editing style),

The edit that adds pixels according to the first editing style may be an edit that adds lines of pixels to the scene image along a horizontal direction of the scene image, or an edit that adds lines of pixels to the scene image along a vertical direction of the scene image.

Here, a line of pixels may be constituted of a plurality of pixels. For example, when the first editing style is applied to a specific scene image comprising 250 pixels horizontally and 400 pixels vertically, with 10 lines of pixels added along the horizontal direction, the horizontal pixels of the specific scene image may be constituted of 260 pixels and the vertical pixels may be constituted of 400 pixels. In this case, the horizontal and vertical ratio of the scene image may be changed from 5:8 before editing to 13×20 after editing. That is, through the first edit, the horizontal and vertical ratio of the scene image (or a ratio of the scene image, a size ratio of the scene image) may be changed. As another example, when the first editing style is applied to a specific scene image comprising 250 pixels horizontally and 400 pixels vertically, with 10 lines of pixels added along the vertical direction, the horizontal pixels of the specific scene image may be constituted of 250 pixels and the vertical pixels may be constituted of 410 pixels. In this case, the horizontal and vertical ratio of the scene image (or a ratio of the scene image, or a size ratio of the scene image) may be changed from 5:8 before editing to 25×41 after editing.

When an edit is made that adds a pixel according to the first editing style, the control unit 130 may generate the added pixel using pixels in an area adjacent to an area to which the pixel is added. The control unit 130 may add pixels that have the same or similar color to the color of pixels in an area adjacent to the area in which the pixels are added to the scene image.

The edit that removes pixels according to the second editing style may be an edit that removes some lines of pixels of a scene image along the horizontal direction of the scene image, or an edit that removes some lines of pixels of the scene image along the vertical direction of the scene image. As described above, a line of pixels may be constituted of a plurality of pixels. For example, when the second editing style is applied to a specific scene image comprising 250 pixels horizontally and 400 pixels vertically, with 10 lines of pixels removed along the horizontal direction, the horizontal pixels of the specific scene image may be constituted of 240 pixels and the vertical pixels may be constituted of 400 pixels. In this case, the horizontal and vertical ratio of the scene image may be changed from 5:8 before editing to 3×5 after editing. That is, through the second edit, the horizontal and vertical ratio of the scene image (or a ratio of the scene image, a size ratio of the scene image) may be changed. As another example, when the second editing style is applied to a specific scene image comprising 250 pixels horizontally and 400 pixels vertically, with 10 lines of pixels removed along the vertical direction, the horizontal pixels of the specific scene image may be constituted of 250 pixels and the vertical pixels may be constituted of 390 pixels. In this case, the horizontal and vertical ratio of the scene image (or a ratio of the scene image, or a size ratio of the scene image) may be changed from 5:8 before editing to 25×39 after editing.

For the edit that keeps the scene image unedited according to the third editing style, a scene image before editing and a scene image after editing may be the same. In this case, the number and ratio of scene images before editing and after editing may be the same.

As described above, when editing is performed on a plurality of scene images to be edited, a post-editing aspect ratio of at least some scene images of the plurality of scene images may be different from a pre-editing aspect ratio of the at least some scene images.

Whether an aspect ratio of any scene image of the plurality of scene images has been changed may vary depending on the user information.

As described above, in the present invention, at least some of the scene images of a plurality of scene images may be changed in aspect ratio, and as a result, the size of at least some of the scene images of the plurality of scene images may be changed. In the present invention, this may be expressed as resizing a scene image. In the present invention, editing a scene image may also be understood as resizing a scene image. The term “editing” may be changed and used as “resizing” or “retargeting” and the like.

The control unit 130 may, on the basis of the user information, edit each of a plurality of scene images using a combination of the first to third editing styles described above. This will be more specifically described below.

Through such editing, a plurality of edited scene images are provided to the user terminal, and the plurality of scene images provided to the user terminal are constituted to include user information.

A degree of pixels (or lines of pixels) being removed or inserted may be predefined in each edit code. For example, when the types of code values are 0, 1, and −1, the degree (amount or number) of pixels being removed or inserted may be pre-matched to a code value of 1, which indicates an insertion of a pixel, and a code value of −1, which indicates a removal of a pixel, according to each code value. For example, the code value of 1 may correspond to an addition of 10 lines of pixels, while the code value of −1 corresponds to a removal of 10 lines of pixels.

Further, when the types of code values are diversified, the degree of addition or removal of lines of pixels may be further diversified. For example, when the code value is −1, −2, 0, 1, or 2, the code value of 2 may correspond to an addition of 20 lines of pixels, the code value of 1 may correspond to an addition of 10 lines of pixels, the code value of −1 may correspond to a removal of 10 lines of pixels, and the code value of −2 may correspond to an addition of 20 lines of pixels.

As described above, each code value determines an editing level for how and to what extent to edit a scene image (to what extent to add or remove pixels), and the control unit 130 may perform editing of a plurality of scene images constituting content on the basis of a preset editing level matched to each code value. The editing level may also be understood as the number of lines of pixels forming an area to be edited in a scene image.

The control unit 130 may perform editing on a plurality of scene images constituting original content according to an edit code matched to each of the user information on the basis that the user information is different, even though the control unit 130 receives viewing requests for the same content.

For example, assume that first user information (e.g., ID) is “honggd” as illustrated in FIG. 3(b). The control unit 130 may perform editing a scene image 310 according to an editing style (the second editing style) that removes some pixels of the scene image 310 constituting original content on the basis of the first user information. An edited scene image 320 may have a visual appearance that has a reduced area corresponding to the removed pixels (an area corresponding to L2 is smaller than an area corresponding to L1), compared to the original scene image 310.

As another example, assume that second user information (e.g., ID) is “kimstar”, as illustrated in FIG. 3(c). The control unit 130 may perform editing the scene image 310 according to an editing style (the second editing style) that inserts additional pixels of the scene image 310 constituting the original content into the scene image 310 on the basis of the second user information. That is, a different edit may be performed on the original content than an edit that removes the original content on the basis of the first user information. In this case, the edited scene image 330 may have a visual appearance of an increased area (an area corresponding to L3 is greater than areas corresponding to L1 and L2) compared to the original scene image 310 and the scene image 320 from which the pixels were removed.

In the present invention, a process of providing the edited content to the user terminal may proceed (S240, see FIG. 2).

The control unit 130 may provide content comprising the edited scene images to the user terminal 1 in response to at least some of the plurality of scene images being edited on the basis of the user information.

In the present invention, even if the same content is requested to be viewed, differently edited content may be provided to each of the user terminals 1 on the basis that the user information is different. The differently edited content may be displayed on the user terminal 1 with different visual appearances (e.g., different resolutions, different aspect ratios, different horizontal and vertical ratios).

For example, in each of a case in which the original content 310 that has not been edited on the basis of the user information is provided (see FIG. 3(a)), a case in which the content 320 that has been edited to remove pixels is provided based on the first user information (e.g., “ID: honggd”) (see FIG. 3(b)), and a case in which content 330 that has been edited to insert pixels on the basis of the second user information (e.g., “ID: kimstar”) is provided (see FIG. 3(c)), the content 310, 320, and 330 having different visual appearances may each be displayed on the user terminal 1.

As described above, in the present invention, content having different visual appearances according to information on a user viewing the content may be provided, and when content is illegally copied (e.g., captured or photographed) and leaked and distributed, a leaker may be detected on the basis of the degree of editing of the leaked content.

The control unit 130 may, on the basis of the user information, perform editing a plurality of scenes constituting the content by combining the first editing style, the second editing style, and the third editing style as described above. As a result, the content with different visual appearances may be provided to the user terminal 1. For each of the plurality of scene images constituting the content, whether editing is to be performed according to any one of the first to third editing styles may be determined on the basis of the user information.

The user information is constituted of at least one character, and first matching information in which different codes are matched to each of different characters, and second matching information in which one of the first editing style, the second editing style, or the third editing style is matched to each of the different code values constituting the code, are stored in the system 100 for providing content (or storage unit) that provides the content. In this case, different editing styles may be matched to different code values. At least one of the first matching information or the second matching information may be present as information in the form of a table. The control unit 130 may perform editing to reflect the user information in a plurality of scene images with reference to at least one of the first matching information or the second matching information.

The control unit 130 may identify a specific edit code corresponding to the user information on the basis of the first matching information, and perform editing of the plurality of scene images according to an editing style matched to each of the code values constituting the specific edit code. The control unit 130 may perform editing of a plurality of scene images with reference to an edit code corresponding to the user information.

As described above, the control unit 130 may provide the user terminal with content constituted of a plurality of scene images having different visual appearances on the basis that at least one of i) a type of character, ii) the number of characters (or a length of a column of characters), iii) an edit code matched to the character, or iv) the number of digits of the edit code, of the characters constituting the user information is different.

The edit code illustrated in FIG. 4 may be set by an administrator of the system 100 or may be set by the control unit 130.

The edit code may be understood as information that defines an editing style for which of the first to third editing styles described above is to be used to perform editing on original content. In addition, the edit code may be understood as information that defines which scene image, among the plurality of scene images constituting the content requested to be viewed, needs be edited in what order and with what editing style.

The control unit 130 may perform editing with an editing style matched to a code value constituting each digit of the edit code for the number of consecutive scene images corresponding to the number of digits constituting the edit code.

For example, as illustrated in FIG. 4, when the edit code has three digits, the control unit 130 may perform editing on three consecutive scene images (e.g., the first scene image to the third scene image). In this case, the control unit 130 may edit the first scene image with an editing style matched to a first code value, the second scene image with an editing style matched to a second code value, and the third scene image with an editing style matched to a third code value.

Each of the code values (e.g., “0”, “1”, “−1”) that constitutes the edit code may be matched to one of a plurality of editing styles. For example, a code value of “1” may be matched to an editing style (or the first editing style) that additionally inserts pixels forming a specific area of the scene image into the scene image, a code value of “−1” may be matched to an editing style (or the second editing style) that removes pixels forming a specific area of the scene image from the scene image, and a code value of “0” may be matched to an editing style (or the third editing style) that keeps the scene image unedited.

The control unit 130 may determine the number of digits (scenes) of the edit code on the basis of the number of characters and the number of editing styles (stages) available for constituting the user information, as shown in equation 1 below. In the present invention, determining the number of digits of the edit code may be understood as the number of scene images to be edited to reflect one character. That is, the control unit 130 may specify the number of scene images that are required as a minimum to express all of the characters available for constituting the user information.

Characters=stages^{scenes} [EQUATION 1]

For example, when the user information is in the English alphabet, the number of letters of the alphabet may be 26. The control unit 130 may determine, on the basis of the equation, at least one of a type of code value and the number of scene images in which each of the 26 letters of the alphabet can be all expressed. In this case, the type (e.g., 1, −1, 0) (or number of types) of the code value matched to an editing style may correspond to a stage in the equation, and the number of scene images required to express the user information may correspond to scenes. When the type of code value is specified, the control unit 130 may determine the number of scene images so that all of the user information can be expressed with reference to the equation. For example, when the code values are specified as three types, 1, −1, and 0, at least three scene images may be required to express the 26 letters of the alphabet (3\hat{ }3=27). In contrast, when the number of scene images is specified, the control unit 130 may determine the type (or number of types) of code values so that all of the user information can be expressed with reference to the equation. For example, when the number of scene images is specified to be 3, at least 3 types of code values may be required to express the 26 letters of the alphabet (3\hat{ }3=27).

The control unit 130 may determine at least one of the number of types of code values (stage) and the number of scene images (scenes) so that the number of characters constituted to express the user information falls within the number of types of code values (stage) to the power of the number of scene images (scenes) derived through the equation.

For example, when the types of code values are three types of code values of 0, 1, and −1, at least three scene images may be required to express an “a” among the user information that can be expressed as the alphabet. In this case, the number of scene images may be understood as the number (number of digits) of code values that constitutes the edit code. In this case, the edit code may be constituted of three digits. The edit code that is constituted of three digits may be constituted of one of 0, 1, or −1 in each code digit, thereby resulting in a combination of a total of 27 edit codes. In this case, all 26 letters of the alphabet may be expressed.

The example above shows that 26 characters are expressed. For another example, in order to express 45 characters, each of the 45 characters may be expressed when there are three types of code values (e.g., 0, 1, −1) and four scene images (4-digit edit codes) (3\hat{ }4=81).

As described above, the control unit 130 inserts the user information in the plurality of scene images constituting the content through editing the plurality of scene images. In this case, the number of the plurality of scene images is determined on the basis of the number of characters constituting the user information.

That is, the number of the plurality of scene images required to insert the user information varies depending on the number of characters constituting the user information. For example, when the number of code values (the number of digits of the edit code) required to express a different character (unit character) is 3 (or 3 digits), and the number of characters constituting the user information is 4 (e.g., an ID corresponding to the user information: abcd), the number of the plurality of scene images required to insert the user information may be 12. That is, “3 scene images” are required to express each character (unit character). Therefore, to express a 4-digit character, 12 scene images are required, corresponding to “3” scene images required to express a unit character × (multiplied by) “4”, which is the number of characters constituting the user information.

As described above, the number of digits of the edit code (the number of code values) is the minimum number of scene images required to express one character. For example, three scene images are required to express one letter of the alphabet, and nine scene images are required to express three letter of the alphabet.

The number of types of code values and the number of scene images (the number of digits of edit code, the number of code values) may vary depending on the number of characters available for constituting the user information.

The control unit 130 may, on the basis of the number of characters constituting the user information, specify the number of a plurality of scene images required to insert the user information, and perform editing to insert the user information in the plurality of scene images corresponding to the number among the scene images constituting the content requested to be viewed.

Further, the control unit 130 may specify an editing style to be applied to each of the plurality of scene images according to a code value constituting an edit code corresponding to the user information.

The control unit 130 may perform editing on a plurality of scene images on the basis of the editing style of a code value constituting an edit code corresponding to the user information, for each of the plurality of scene images specified as an editing target.

For example, assume that the user information is “honggd”, which is constituted of six characters, as illustrated in FIG. 5. As described above, in the case of 6 characters, the number of scene images required to express the user information once may be 18. The control unit 130 may insert the user information using the 18 consecutive scene images. In this case, since the required scene images to express one character are three, and the user information is a six-letter character, a total of 18 scene images are required. Therefore, the control unit 130 may perform editing on a total of 18 scene images to express the user information of “honggd”.

The control unit 130 may, on the basis of at least one of the first matching information or the second matching information described above, identify an edit code corresponding to each character, and edit the scene image according to an editing style matched to a code value of the corresponding edit code. In this case, each digit of the edit code may correspond to an arrangement order of the scene image to be edited.

For example, when an edit code 81 of “h”, which is a first character 31, is {0, 1, −1}, the control unit 130 may edit a first scene image (first scene image 21) of three consecutive scene images with an editing style matched to a code value of “0” disposed in a first digit (e.g., the third editing style that keeps the scene image unchanged), edit a second scene image (second scene image 22) with an editing style matched to a code value of “1” (e.g., the first editing style that inserts a specific pixel into the scene image), and edit a third scene image (third scene image 23) with an editing style matched to a code value of “−1” (e.g., the second editing style that removes a specific pixel from the scene image). Further, on the basis that an edit code of “O”, which is a second character 32, is {−1, −1, 1}, the control unit 130 may edit a fourth scene image 24 with an editing style (the second editing style to remove a pixel) matched to a code value of “−1”, edit a fifth scene image (not illustrated) with an editing style (the second editing style to remove a pixel) matched to a code value of “−1”, and edit a sixth scene image (not illustrated) with an editing style (the first editing style to insert a pixel) matched to a code value of “1”. With the method as described above, the control unit 130 may perform editing on a total of 18 scene images to express the user information of “honggd”. The control unit 130 may repeatedly perform editing on scene images constituting content in units of the number of scene images required to express the user information (e.g., 18) to insert the user information into the content in whole or in part.

The control unit 130 may perform editing by selecting an area of relatively low importance in the scene image so that a user's use of content is not interfered with and the user is not aware of the editing of the content. The control unit 130 may not allow an area of a scene image that includes a story (or graphic object) of high importance (which may be referred to as an “edit restriction area”) to be edited, and may allow an area that includes an object of low importance (which may be referred to as an “edit target area”) to be edited.

The areas of low or high importance in the scene image may be determined on the basis of various references. For example, the control unit 130 may specify an area to be edited on the basis of the user information, with reference to pixel energy of each of a plurality of pixels constituting a scene image. In the present invention, energy may also be referred to as an energy level. The control unit 130 may specify an area with a low energy level in each scene image using a content modification-based retargeting technique, such as seam carving, and specify the area as an edit target area.

Here, “pixel energy” may be understood as a degree of complexity of a pixel. For example, the control unit 130 may obtain (calculate or compute) pixel energy on the basis of at least one of a gradient magnitude, entropy, visual salience, and an eye gaze movement on a pixel.

The control unit 130 may calculate a sum of pixel energy of pixels forming a line along one direction in the scene image, and detect a line with the smallest sum of pixel energy. The control unit 130 may specify an area (or a pixel) corresponding to a line with the smallest sum of detected pixel energy as an area to be edited (or a pixel to be edited).

For example, as illustrated in FIG. 6, a specific line 510 with the smallest sum of pixel energy of pixels that form a line along a horizontal direction in a scene image 410 may be detected. The control unit 130 may specify an area (or pixel) corresponding to the detected line 510 as an area (pixel) to be edited.

As another example, an area of low importance (an edit target area) or an area of high importance (an edit restriction area) of a scene image may be determined on the basis of at least one of the type of a graphic object included in the scene image or the story (or meaning) of the graphic object.

The control unit 130 may not allow an area including an important graphic object or a graphic object corresponding to an important story (or meaning), that is, an object of high importance, to be edited. The type of graphic object that is important, or what the story (or meaning) of the graphic object is, may be based on a preset reference stored in the storage unit (120) and accessible by the control unit (130).

The control unit 130 may, on the basis of the preset reference, specify an area of the scene image that includes an important graphic object as an edit restriction area, and perform editing on the remaining area (an edit target area). The control unit 130 may control such that pixels that include an important graphic object are not detected (specified) as an area (or line) to be edited. That is, the pixels that include an important graphical object may be an edit restriction area.

For example, as illustrated in FIG. 6, when objects corresponding to a speech bubble 412, text 413, and a face 414, which are a preset reference and set as important objects, the control unit 130 may set an area that includes the corresponding objects 412, 413, and 414 as an edit restriction area, and set the remaining area as an edit target area. The control unit 130 may perform editing on an area that does not include the corresponding objects 412, 413, and 414. Thus, the control unit 130 may set an edit target area on the basis of important objects according to the energy level described above or the preset reference, when the scene image 410 includes a tree image 411, the speech bubble 412, the letter 413, and the face 414.

Further, the control unit 130 may perform editing on an area with low pixel energy (that is, an edit target area) in the scene image according to an edit code matched to the user information.

When an edit code to “remove” low energy pixels is matched to the user information, the control unit 130 may perform editing to remove low energy pixels 510. For example, a scene image 420 edited as illustrated in FIG. 7(a) may include a trunk of a tree 421 that has been shortened by removing pixels with low energy.

When an edit code that “inserts” pixels with low energy into a scene image is matched to the user information, the control unit 130 may perform editing to duplicate (clone, copy) the pixels with low energy and insert the pixels into the scene image. For example, a plurality of duplicated pixels 530 with low energy may be inserted into a scene image 430 that has been edited as illustrated in FIG. 7(b). The edited scene image 430 may include a trunk of a tree 431 that has been elongated by inserting pixels with low energy.

As described above, the method and a system for providing content according to various embodiments of the present invention can edit and provide an image on the basis of user information, thereby inserting the user information into the image constituting the content.

In the present invention, user information can be inserted into content by simply removing or editing an image, thereby detecting various types (screen capture, photographing with a camera, or the like) of illegal copying and distribution of content.

According to various embodiments of the present invention, distortions to an important story of content can be avoided by retaining the important story of an image, and performing editing only on the remaining area.

Further, the present invention described above may be implemented as computer-readable code or instructions on a medium in which a program is recorded. That is, the various control methods according to the present invention may be provided in the form of a program, either in an integrated or individual manner.

The computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or a cloud storage that includes storage and that an electronic device may access through communication. In this case, the control unit 130 may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined based on the reasonable interpretation of the appended claims, and all of the modifications within the equivalent scope of the present invention belong to the scope of the present invention.

What is claimed is:

1. A method of providing content executed by a control unit comprising:
receiving a viewing request for content from a user terminal;
identifying user information for a user account logged in to the user terminal at the user terminal;
editing a plurality of scene images constituting the content, on the basis of the user information; and
providing the content that includes the plurality of edited scene images to the user terminal.

2. The method of claim 1, wherein a post-editing aspect ratio of at least some scene images of the plurality of scene images may be different from a pre-editing aspect ratio of the at least some scene images after the plurality of scene images is edited.

3. The method of claim 2, wherein a change in an aspect ratio of any scene image of the plurality of scene images varies depending on the user information.

4. The method of claim 1, wherein each of the plurality of scene images is edited according to one of a first editing style, a second editing style, or a third editing style,
the first editing style is an editing style that inserts a pixel into a scene image to be edited among the plurality of scene images,
the second editing style is an editing style that removes some pixels of the scene image to be edited among the plurality of scene images, and
the third editing style is an editing style that retains the scene image to be edited among the plurality of scene images.

5. The method of claim 4, wherein the editing of the plurality of scene images is performed in combination of the first editing style, the second editing style, and the third editing style, on the basis of the user information.

6. The method of claim 5, wherein whether editing is to be performed according to any one of the first to third editing styles for each of the plurality of scene images is determined on the basis of the user information.

7. The method of claim 6, wherein first matching information having a different edit code matched to each of different characters that are available for setting as the user information and second matching information having one of the first editing style, the second editing style, or the third editing style matched to each of different code values constituting the edit code, are present in a system for providing the content,
wherein different editing styles are matched to the different code values.

8. The method of claim 7, wherein the edit code includes a plurality of code values disposed in different digits, and
wherein the number of the plurality of code values constituting the edit code is determined depending on the number of the different characters.

9. The method of claim 8, wherein the number of the plurality of code values is a minimum number of scene images required to express each of the different characters.

10. The method of claim 7, wherein in the editing of the plurality of scene images, a specific edit code corresponding to the user information is identified on the basis of the first matching information, and the plurality of scene images is edited according to an editing style matched to each of the code values constituting the specific edit code.

11. The method of claim 1, wherein in the editing of the plurality of scene images, the user information is inserted into the plurality of scene images through the editing of the plurality of scene images.

12. The method of claim 1, wherein the number of the plurality of scene images varies according to the number of characters constituting the user information.

13. The method of claim 1, wherein in the editing of the plurality of scene images, an edit target area in which editing is to be performed is specified for each of the plurality of scene images on the basis of a preset reference, and
wherein the editing of the plurality of scene images is performed such that the edit target area includes the user information.

14. The method of claim 13, wherein the preset reference corresponds to a type of graphical object included in the plurality of scene images, and
wherein in the editing of the plurality of scene images, editing is performed on a remaining area except for an area that includes an important object in each of the plurality of scene images, according to the preset reference.

15. The method of claim 13, wherein in the editing of the plurality of scene images, the edit target area is specified with reference to pixel energy of a plurality of pixels constituting each of the plurality of scene images.

16. A system for providing content comprising:
a communication unit configured to receive a viewing request for content from a user terminal; and
a control unit configured to identify user information for a user account logged in to the user terminal,
wherein the control unit edits a plurality of scene images constituting the content on the basis of the user information, and provides the edited content to the user terminal.

17. A non-transitory computer-readable recording medium storing a program for providing content, the program, enabling a control unit to perform the steps comprising:
receiving a viewing request for content from a user terminal;
identifying user information for a user account logged into the user terminal;
editing a plurality of scene images constituting the content on the basis of the user information; and
providing the edited content to the user terminal.
